(19) United States
(12) Patent Application Publication
(10) Pub. No.: US 2014/0075681 A1
(43) Pub. Date: Mar. 20, 2014

(54) Pencil Sharpener

(71) Applicant: Walter Hammer, Newtown, PA (US)

(72) Inventor: Walter Hammer, Newtown, PA (US)

(21) Appl. No.: 14/090,998

(22) Filed: Nov. 26, 2013

Related U.S. Application Data
(63) Continuation-in-part of application No. 13/094,804, filed on Apr. 26, 2011, now abandoned.

(51) Int. Cl. B43L 23/08; B25F 1/00

(52) U.S. Cl. CPC B43L 23/08; B25F 1/00
USPC 7/151; 30/451; 7/160; 76/104.1

(57) ABSTRACT

A pencil-sharpener tool for carpenter pencils includes a housing, a pencil-tip-insertion hole, and a hex-bit-drive hole. The pencil-tip-insertion hole may configured in to receive a portion of a carpenter pencil. The hex-bit-drive hole may extend at least partially through the housing opposite the pencil-tip-insertion hole. The hex-bit-drive hole may also be in axial alignment with the pencil-tip-insertion hole and the central axis of the housing. The housing, the pencil-tip insertion hole, and the hex-bit-drive hole may be in fixed relation to each other, and may move in unison when the hex bit is inserted inside the hex-bit-drive hole and rotates clockwise or counterclockwise.

### CROSS REFERENCE TO RELATED APPLICATIONS

The present patent application is a Continuation-in-Part of application Ser. No. 13/094,804 to which the present application claims priority and incorporates herein by reference. U.S. Patent Application Ser. No. 13/094,804 is a non-provisional utility patent which claims priority to application Ser. No. 61,343,181 filed Apr. 26, 2010, to Walter Hammer, entitled “Drill Mounted Adapter for Carpenters Pencil Sharpeners”, which is incorporated herein by reference.

### TECHNICAL FIELD

This patent application is related to devices for sharpening pencils. More specifically, the present patent application pertains to devices for sharpening pencils, including carpenter pencils using a drill.

### BACKGROUND

A carpenter pencil is usually rectangular in shape, which is intended to stabilize the pencil when places on a flat or angled surface to prevent it from rolling.

Unfortunately, because of its shape a carpenter pencil is not compatible with a conventional-cylindrical-pencil sharper for sharpening cylindrically shaped, wooden pencils. Specifically, a carpenter pencil is too large for the opening of a pencil sharpener for cylindrically shaped pencils.

There is generally only one category of dedicated-sharpener devices available for sharpening carpenter pencils; manual. These sharpeners are usually inexpensive and portable, but are very slow. For instance, it can take well over one minute to sharpen a carpenter pencil using a manual sharpener on the market today, among other drawbacks.

The author and inventor would like to appreciatively acknowledge the contribution of Elizabeth Levasseur of The Loft—Automation Design Group, LLC (32 Pheasant Lane, New Boston, N.H. 03070) for her expertise and drafting of technical drawings.

### SUMMARY

Described herein is a pencil-sharpener tool that may be used to sharpen carpenter pencils. The sharpener includes a housing, a pencil-tip-insertion hole, and a hex-bit-drive hole. The pencil-tip-insertion hole may extend at least partially through the housing, and may be aligned axially with a central axis of the housing. The pencil-tip-insertion hole may have a shape and size configured to receive a portion of a carpenter pencil.

Opposite the pencil-tip-insertion hole is the hex-bit-drive hole, which may extend at least partially through the housing. The hex-bit-drive hole may also be in axial alignment with the pencil-tip-insertion hole and the central axis of the housing. The hex-bit-drive hole may have a shape and size configured to receive at least a portion of a hex bit, when inserted inside the hex-bit-drive hole.

The housing, the pencil-tip insertion hole, and the hex-bit-drive hole may be in fixed relation to each other, and may move in unison with respect to each other, when a hex bit is inserted inside the hex-bit-drive hole and rotates clockwise or counterclockwise.

Additional objects, features, and advantage of the invention will become apparent to those skilled in the art upon consideration of the following detailed description of a preferred embodiment exemplifying the best mode of carrying out the invention as presently perceived.

It is an object of the present invention to provide a manual or powered carpenter's pencil sharpener combined with one or more additional and related functions. Such functions include a level, a hex bit storage device and/or a bottle opener. Such functions may be required or desired by users of the present invention in conjunction with sharpening functionality.

Another object of the present invention is to provide an efficient and economical means of sharpening carpenter's pencils in a manual or powered fashion, in conjunction with other functionality such as a bubble level, hex it storage and/or a bottle opener.

Other objects, features and advantages of the present invention will become apparent from the following detailed description taken in conjunction with the accompanying drawings

### BRIEF DESCRIPTION OF THE DRAWINGS

The detailed description is presented with reference to the accompanying figures. In the figures, the left-most digit(s) of a reference number identifies the figure in which the reference number first appears. It is emphasized that the various features in the figures are not drawn to scale, and dimensions of the various features may be arbitrarily increased or reduced for clarity of discussion.

FIG. 1 is a perspective view of a sharpener for sharpening carpenter pencils.

FIG. 2 shows a side-cross-sectional view of an example sharpener.

FIG. 3 shows an exploded-perspective view of an example sharpener.

FIG. 4 shows a cross-sectional-side view of an example sharpener.

FIG. 5 shows top view of a distal end of an example sharpener.

FIG. 6 shows a side perspective view of a carpenter pencil and hex bit before engagement inside an example sharpener.

FIG. 7 shows a side-perspective view of a carpenter pencil and hex bit engaged inside an example sharpener.

FIG. 8 is a perspective view of a sharpener showing exploded view of bubble level insert and “line level” hooks.

FIG. 9 is a perspective view of a sharpener with hex bit storage cavities.

FIG. 10 is a perspective view of a sharpener showing exploded view of bubble level, bottle opener and drive hole cavity.

FIG. 11 is a perspective view of a sharpener with bubble level and bottle opener.

FIG. 12 shows a cross-sectional-side view of an example sharpener.

### DETAILED DESCRIPTION

FIG. 1 is a perspective view of a sharpener 100 for sharpening carpenter pencils. The illustrated embodiment of sharpener 100 includes: a housing 102, a pencil-tip-insertion hole 104 (not visible in FIG. 1), a hex-bit-drive hole 106, a blade-retention slot 108, a blade 110, mountings 112, a point well 114, a shaving discharge slot 116, and a blade-reinforcement edge 118.

### Example Housing

Housing 102 may be constructed of any suitable material that can withstand the rigors of being used in a construction environment. For instance, housing 102 may be constructed of resilient plastic, aluminum, fiberglass, steel, wood, or any combination thereof.

In one embodiment, housing 102 is pocket sized, being generally hexagonal in shape, and is approximately 3.0 inches in length, and about 0.85 inches thick. The hexagonal shape makes gripping sharpener 100 easy, and prevents it from rolling when set down on a flat or angled surface. Chamfered edges (also referred to as beveled edges) may also be included as part of body 102.

As appreciated by those skilled in the art, after having the benefit of this disclosure, housing 102 may be of other sizes, and shapes such as spherical, rectangular, or other configurations.

Housing 102 provides a framework for a person to grasp sharpener 100, and to withstand torquing forces imparted on housing 102 when housing 102 is rotated by a drill or electric driven bit as will be explained.

A center axis 120 runs lengthwise from a proximal end 122 to a distal end 124 of housing 102.

### Example Pencil-Tip-Insertion Hole

Located at proximal end 122 of housing 102 is pencil-tip-insertion hole 104. FIG. 2 shows a side-cross-sectional view of sharpener 100. In one embodiment, pencil-tip-insertion hole 104 includes an insertion portion 202 (FIG. 2) which is cylindrical in shape, and large enough to receive at least a portion of a shaft of an unsharpened carpenter pencil.

For instance, in one embodiment, insertion portion 202 of pencil-tip-insertion hole measured in lengthwise-axial direction from proximal end 122. As appreciated by those skilled in the art, after having the benefit of this disclosure, insertion portion 202 may be of other sizes, and shapes such as rectangular, or corresponding to the general outer-boundary shape of a carpenter pencil.

Still referring to the example of FIG. 2, pencil-tip insertion hole 104 also includes a conical portion 204, which tapers inwardly toward center axis 120, as pencil-tip insertion hole 104 approaches an approximate center of housing 102 measured about midway between proximal end 122 and distal end 124.

In one embodiment, an angle a for the tapering of inner sides 208 of conical portion 204 is approximately 23 degrees. Additionally, conical portion 204 has a length A′ of approximately 1.25 inches. As appreciated by those skilled in the art with the benefit of this disclosure, however, larger or smaller angles for a (such as ranging between 18 and 40 degrees) or sizes for length A′ of conical portion 204 may be implemented depending on the shape and sharpness desired for the tip of a pencil.

Referring to FIGS. 1 and 2, point well 114 is at a distal end 124 of conical portion 204 of pencil-tip insertion hole 104. As shown in FIG. 1, point well 114 provides an opening for a lead/graphite point to reside when a pencil is sharpened. Referring to FIG. 2, well point 114 has a length B′ and a width C′. In one embodiment, B′ is approximately 0.10 inches C′ is approximately 0.20 inches; although other suitable dimensions may be implemented for B′ and C′, as would be appreciated by those skilled in the art having the benefit of this disclosure.

Although pencil-tip-insertion hole 104 is generally described here and shown in the examples may take different configurations. For example, insertion point 202 may not be needed, and inner sides 208 width of conical portion 204 may be asymmetrical. Other suitable configuration may be implemented for pencil-tip-insertion hole 104, as appreciated by those skilled in the art, after having the benefit of this disclosure.

In one embodiment, pencil-tip-insertion hole 104—including its example constituent parts such as insertion point 202, conical portion 204, and well point 114—is aligned axially about central axis 120. Nevertheless, it is possible for “alignment” between pencil-tip-insertion hole 104 and central axis 120, to be slightly off as result of intentional misalignment, or a tolerance variation, as should be appreciated by those skilled in the art, after having the benefit of this disclosure.

In one embodiment, pencil-tip-insertion hole 104, including its example constituent parts, are fixed in relation to housing 102, and do not rotate or move independently of housing 102. That is, in one example, housing 104 and pencil-tip-insertion hole 104 move in unison and do not move independently of from each other.

### Example Blade-Retention Slot

Referring to FIG. 1, blade-retention slot 108 is an angled-cutout portion of body 102. Specifically, in one embodiment, blade-retention slot 108 corresponds in length, size, and angle of an outer side 126 of conical portion 204 (FIG. 2). The length of blade-retention slot 108 also includes the additive length well point 114.

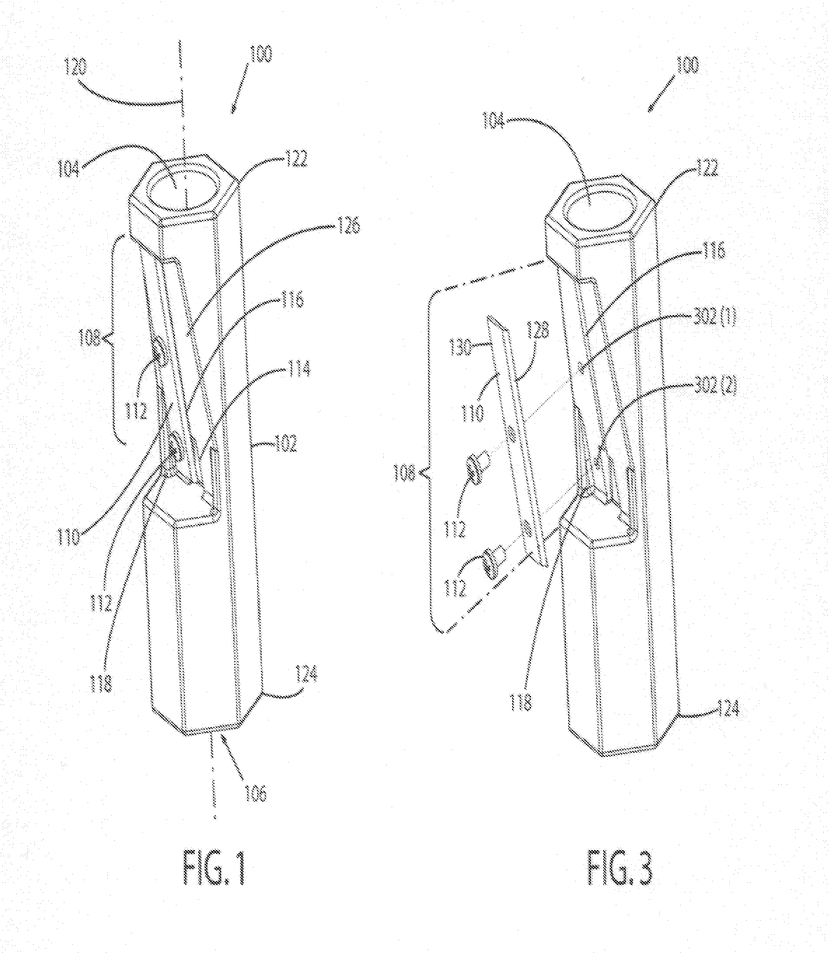

FIG. 3 shows an exploded-perspective view of sharpener 100. With respect to FIG. 3, blade-retention slot 108 includes blade 110, mounting holes 302(1), 302(2), a shaving discharge slot 116, and a blade-reinforcement edge 118.

Shaving-discharge slot 116 is a gap that in one embodiment runs a length of conical portion 204 (FIG. 2), although the size of the gap may be larger or smaller in different implementations. Beside allowing shavings from a pencil to be expelled from the inside of pencil-tip-insertion hole 104, shaving-discharge slot 116 also serves as a gap for a cutting edge 128 of blade 110 to contact a pencil in pencil-tip-insertion hole 104 when inserted therein.

Mountings 112, such as screws, pins, bolts, solder or other fastening means may be used to fasten blade 110 to housing 110 to housing 102. Alternatively, blade 110 may be fastened to housing 102 without mountings or mounting holes, such as via glue, solder, or other fastening means as would be readily appreciated by those skilled in the art after having the benefit of this disclosure.

Located on a side of blade 110 opposite cutting edge 128, is a non-cutting edge 130 of blade 110. A portion or all of non-cutting edge 130 may be buttressed against a blade-reinforcement edge 118, which prevents blade 110 from moving and shifting when cutting edge 128 engages a pencil. In the examples of FIGS. 1 and 3, only a portion of non-cutting edge 130 is buttressed by blade-reinforcement edge 118.

FIG. 4 shows a cross-sectional-side view of sharpener 100, rotated 90 degrees from the view point of FIG. 2.

### Example Hex-Bit-Drive Hole

Referring back to FIG. 2, a hex-bit-drive hole 106 extends at least partially through housing 102, and opposite pencil-tip-insertion hole 104. In one embodiment, hex-bit-drive hole 106 is in axial alignment with pencil-tip-insertion tool 104 and the central axis 120. Nevertheless, it is possible for “alignment” between hex-bit-drive hole 106 and central axis 120, to be slightly off as result of intentional misalignment, or a tolerance variation, as should be appreciated by those skilled in the art, after having the benefit of this disclosure.

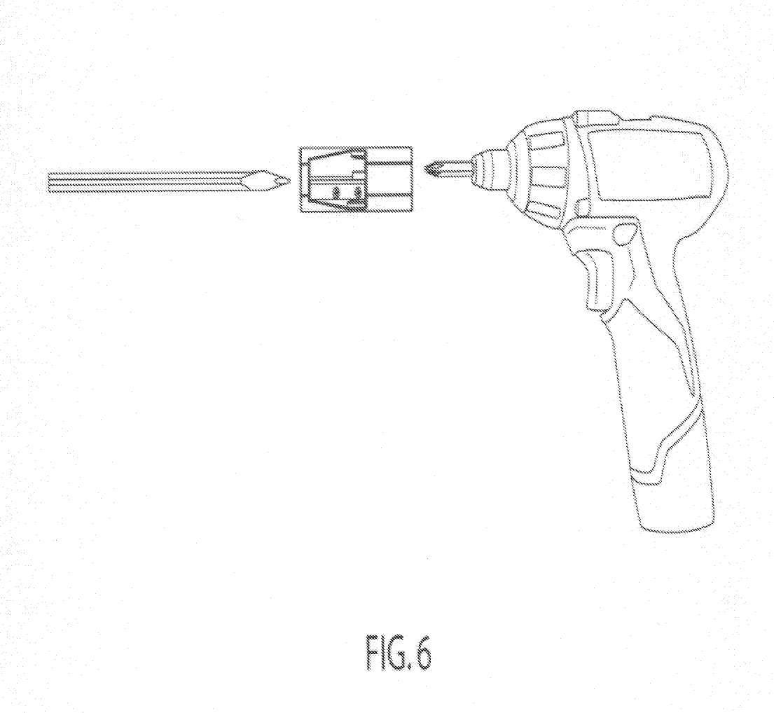

In one embodiment, hex-bit-drive hole 106 has a shape and size configured to (i) receive portion of a hex bit, and (ii) engage the hex bit 602 (shown in FIG. 6) when the hex bit rotates clockwise or counter-clockwise when the hex bit (not shown) is inserted inside hex-bit-drive hole 106 and rotates clockwise or counterclockwise via drill or a powered screwdriver (see also FIG. 6).

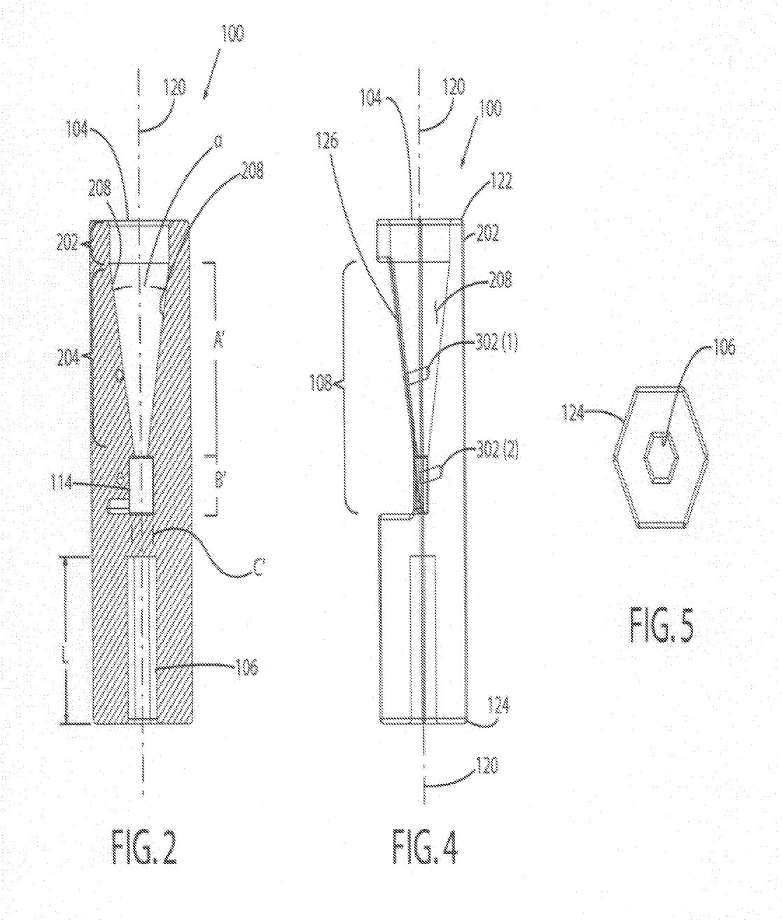

For example, FIG. 5 shows top view of distal end 124 of sharpener 100. As shown in this example, hex-bit-drive hole 106 has a shape of slightly larger than a standard hexagonal-hex bit, such as used with a standard sized Phillips screw driver. That is, hex-bit-drive hole 106 is configured to fit coextensively around the bit of a hex bit (not shown). In one embodiment, hex-bit-drive hole 106 is a fixed chamber inside housing 102, with the shape of hole 106 corresponding to the outer shape of housing 102.

As used herein a “hex bit” means any drive mechanism that attaches to a powered drill or screwdriver, and may be different shapes, sizes, and configurations. For instance, although referred to as a hex (short for hexagonal), hex bit may be square or other shapes.

It is also appreciated that hex-bit-drive hole 106 may include an adapter (not shown) configured to engage different shaped, sized, and configured hex bits. For example, hex-bit-drive hole 106 may include movable members that can be adjusted to fit the size of different hex bits such as a built-in chuck (not shown).

Referring back to FIG. 2, in one embodiment hex-bit-drive hole 106 has a length L, which is approximately 1.0 inches. Nevertheless, as appreciated by those skilled in the art, after having the benefit of this disclosure, hex-bit-drive hole 106 may be of other lengths L, sizes, and shapes, or other configurations.

In one embodiment, hex-bit-drive hole 106 is fixed in relation to housing 102 and pencil-tip-insertion hole 104, and does not rotate or move independently either. That is, in one example, housing 102, pencil-tip-insertion hole 104, and hex-bit-drive hole 106 move in unison and do not move independently of from each other. So, when the hex bit (not shown) rotates clockwise or counter-clockwise it causes housing 102, pencil-tip-insertion hole 104, and hex-bit-drive hole 106 to spin together. Provided a user of sharpener 100 firmly grips the pencil in one hand opposite the end inserted into pencil-tip-insertion hole 104, and the user grasps a powered device in his other hand, only sharpener 100 (and all or most of its constituent parts) will spin thereby sharpening a carpenter pencil.

FIG. 6 shows a side perspective view of a carpenter pencil 604 and hex bit 602 before being inserted inside an example sharpener 100.

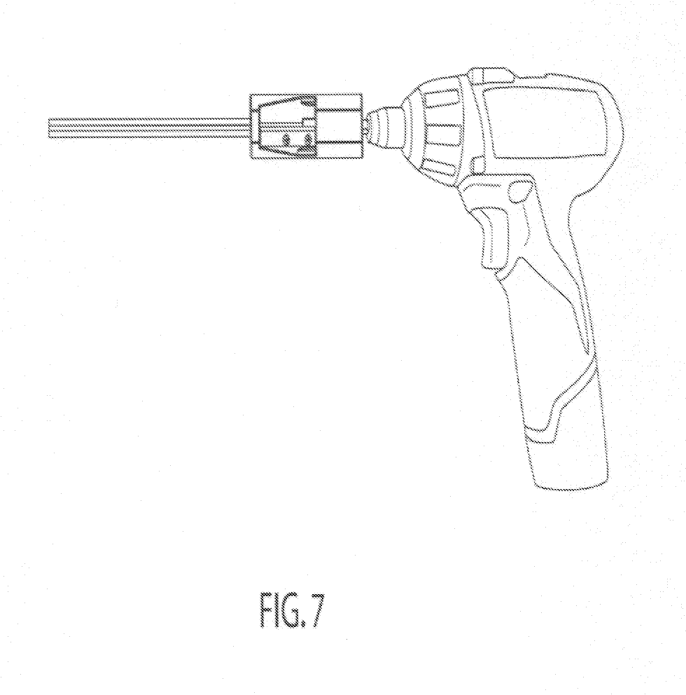

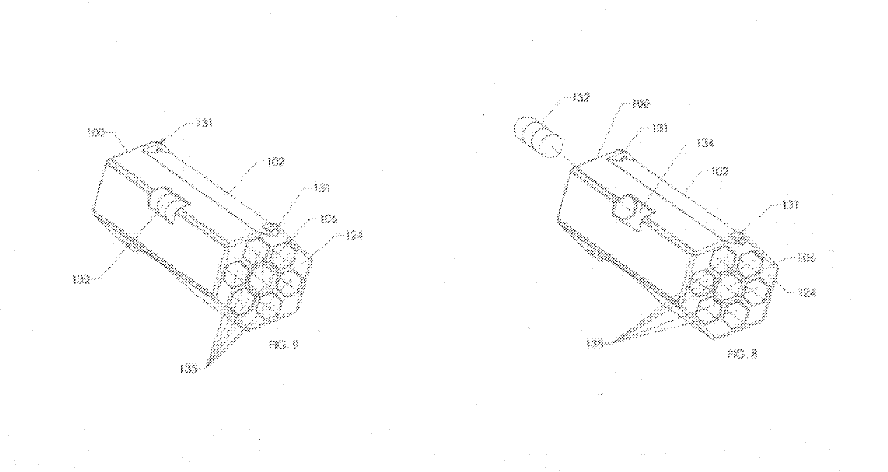

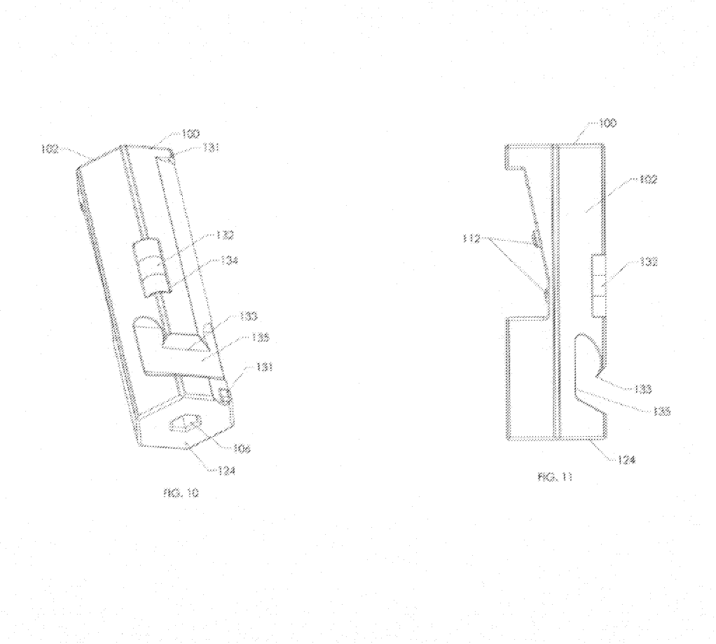

FIG. 7 shows a side perspective view of a carpenter pencil 604 and hex bit 602 after both are inserted inside an example sharpener 100. Again, the user may grasp pencil 604 in one hand, and the drill (or other power source) in the other.

FIG. 8 shows a perspective view of a sharpener 100 for sharpening carpenter pencils. The illustrated embodiment of sharpener 100 includes: a housing 102, a bubble level insertion cavity 134, a bubble level spirit level 132, a hex-bit-drive hole 106, line level string attachment hooks 131, distal end 124, and six auxiliary hex bit storage cavities 135.

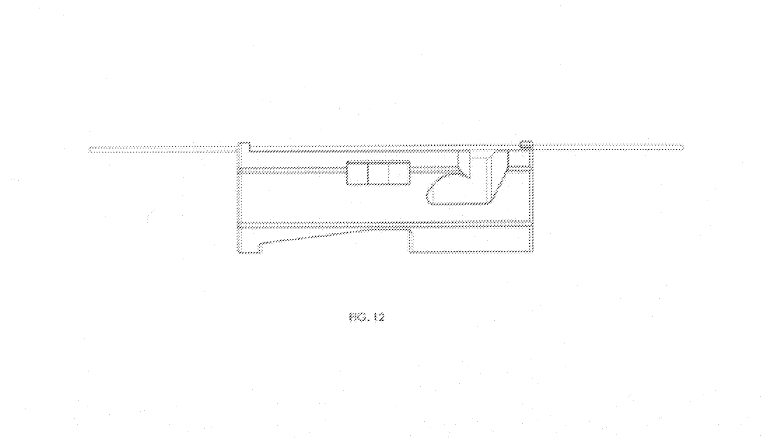

FIG. 9 shows a perspective view of a sharpener 100 for sharpening carpenter pencils. The illustrated embodiment of sharpener 100 includes: a housing 102, a bubble level spirit level 132, a hex-bit-drive hole 106, line level string attachment hooks 131, distal end 124, and six auxiliary hex bit storage cavities 135.

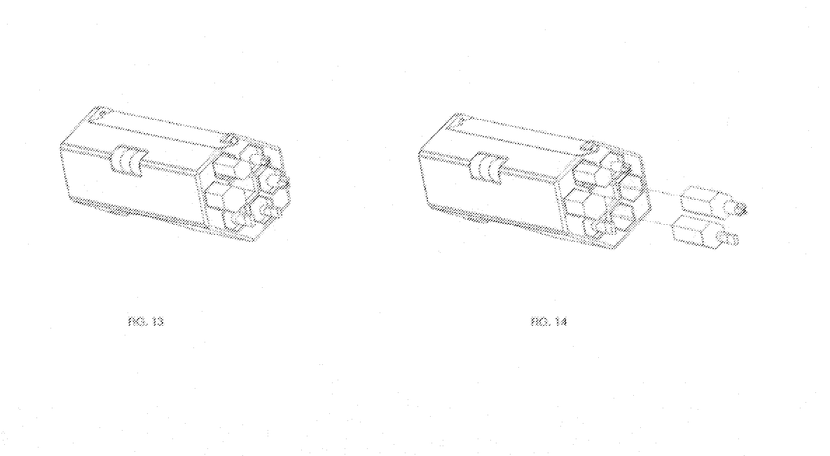

FIG. 10 shows a perspective view of a sharpener 100 for sharpening carpenter pencils. The illustrated embodiment of sharpener 100 includes: a housing 102, a bubble level spirit level 132, a bubble level insertion cavity 134, a hex-bit-drive hole 106, line level string attachment hooks 131, distal end 124, bottle opener pry catch 133, bottle cap insertion cavity 135.

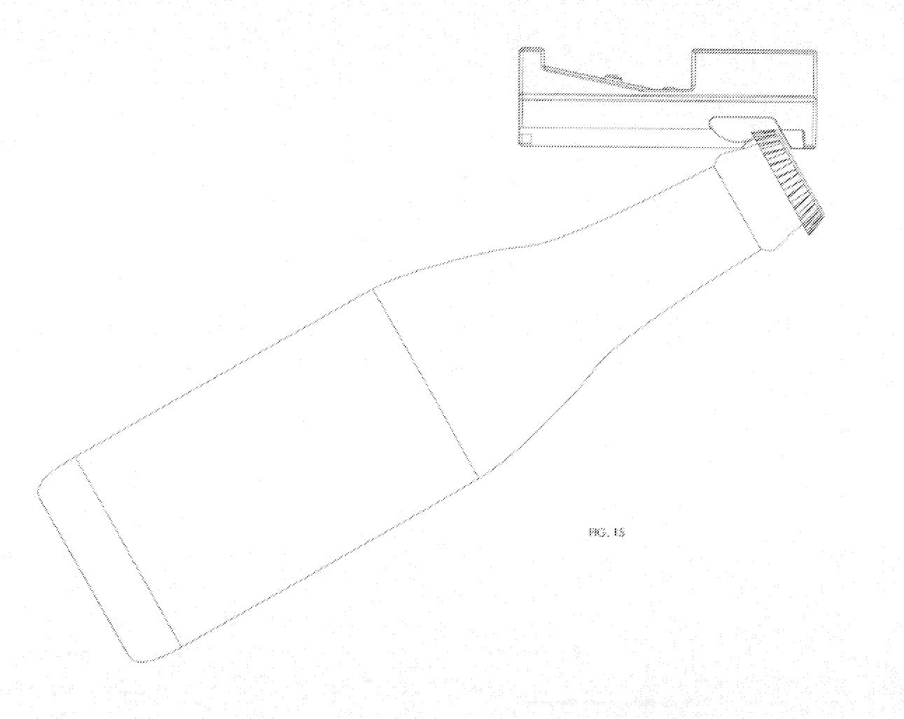

FIG. 11 shows a perspective view of a sharpener 100 for sharpening carpenter pencils. The illustrated embodiment of sharpener 100 includes: a housing 102, a bubble level spirit level 132, distal end 124, bottle opener pry catch 133, bottle cap insertion cavity 135.

### CONCLUSION

Reference herein to “one embodiment”, “an embodiment”, or similar formulations, means that a particular feature, structure, operation, or characteristic described in connection with the embodiment, is included in at least one embodiment, Thus, the appearances of such phrases or formulations herein are not necessarily all referring to the same embodiment. Furthermore, various particular features, structures, operations, or characteristics may be combined in any suitable manner in one or more embodiments.

It is to be understood that the subject of this application is not limited to the embodiments described above, but encompasses any and all embodiments within the scope of the subjoined Claims and their equivalents.

I claim:

1. A manual carpenter pencil sharpener capable of conversion to a powered carpenter pencil sharpener via attachment to a drill using ¼″ drive hole opposite the sharpening cavity, carpenter pencils are described as “a pencil that has a body with a rectangular or elliptical cross-section to stop it from rolling or blowing away, the adapter comprises: a housing including:
a. a carpenter pencil sharpener cavity capable of use as a manual or powered sharpener;
b. and a ¼ drive hole extending in a lengthwise and axial position opposite the sharpening cavity, wherein said drive hole has an inner shape and size complementary to receive a substantial portion of a hex-bit.

2. The sharpener of claim 1, wherein said drive hole is surrounded by a solid material forming a portion of the sharpener.

3. A method comprising the making of a housing, sharpener cavity and hex bit hole in fixed relation to each other such that the housing, the sharpener cavity and the hex bit drive hole move as a single unit when the hex bit drive hole is inserted over a hex bit attached to a drill or mechanical device that rotates clockwise or counter clockwise.

4. The method of claim 3, further comprising configuring the hex bit drive hole to be coextensive with a hex bit.

5. The method of claim 9, further comprising axially aligning the housing, sharpener insertion hole and hex bit drive hole with each other.

6. The sharpener of claim 1, further comprising an inserted bubble level device as well as line and level hooks, giving the additional functionality of a leveling device.

7. The sharpener of claim 1, further comprising one or more hex bit storage holes aligned and surrounding the hex bit drive hole.

8. The sharpener of claim 1, further comprising an inserted bottle opener.

9. The sharpener of claim 1, further comprising one or more of:
a. an inserted bubble level device, as well as line and level hooks,
b. one or more hex bit storage holes aligned and surrounding the hex bit drive hole,
c. and an inserted bottle opener.
